(19) United States
(12) Patent Application Publication
(10) Pub. No.: US 2015/0169373 A1
(43) Pub. Date: Jun. 18, 2015

(54) SYSTEM AND METHOD FOR MANAGING COMPUTING RESOURCES

(71) Applicants: Michael A Salsburg, Phoenixville, PA (US); Nandish Jayaram Kopri, Bangalore (IN); Kelsey L. Bruso, Roseville, MN (US)

(72) Inventors: Michael A Salsburg, Phoenixville, PA (US); Nandish Jayaram Kopri, Bangalore (IN); Kelsey L. Bruso, Roseville, MN (US)

(73) Assignee: Unisys Corporation, Blue Bell, PA (US)

(21) Appl. No.: 14/565,517

(22) Filed: Dec. 10, 2014

Related U.S. Application Data
(63) Continuation-in-part of application No. 14/108,521, filed on Dec. 17, 2013.

(51) Int. Cl. G06F 9/50

(52) U.S. Cl. CPC G06F 9/5011

(57) ABSTRACT

One embodiment of a computer-implemented method for managing computing resources may include determining, by a computer, target computing resources to be configured with a platform. A determination, by the computer, may be made as to whether the target computing resources includes a management agent for managing the platform. The computer may cause a management agent to be installed on the target computing resources if the target computing resources are determined to not include a management agent, otherwise, the computer may not cause a management agent to be installed on the target computing resources. The computer may instruct the management agent to commission the platform on the target computing resources.

### CROSS-REFERENCE TO RELATED APPLICATIONS

This application is a continuation-in-part of co-pending U.S. patent application Ser. No. 14/108,521, filed on Dec. 17, 2013, and also claims priority to U.S. Provisional Patent Application Ser. No. 61/738,161, filed on Dec. 17, 2012, all of which are incorporated by reference in their entirety.

### FIELD OF THE DISCLOSURE

The subject matter disclosed herein relates generally to resource management in a commodity computing environment.

### BACKGROUND

Computing systems sharing various infrastructure and software components have many desirable attributes; however, one of the challenges of using them is to support applications, often mission-critical applications, while taking advantage of low cost “commodity” infrastructure. Such environments can be thought of as “commodity-based” infrastructures in which heterogeneous computing components are amalgamated into a common computing system.

Such computing environments may result in a heterogeneous collective of commodity components, each needing access to applications, data, hardware resources, and/or other computing resources, across the computing system. Often, operating such environments requires developers to possess and/or utilize a variety of commodity skills and tools.

Cloud computing and other computing configurations have to be configured for particular utilization by users. Configuration operations these days are to be seamless to the end user as the end user demands have grown toward simplicity of operations. Moreover, in the case of a cloud computing configuration, an end user does not have possession of the physical computing resources, and, therefore, relies on a user interface to provision, orchestration, and management of computing resources, including physical, logical, and virtual platforms.

### SUMMARY

Disclosed herein is an commodity infrastructure operating system that manages and implements the resources and services found in the heterogeneous components of the common infrastructure.

One embodiment of a process for provisioning computing resources may include communicating, by a computer, with multiple common computing resources. The computing resources may be inclusive of multiple corresponding physical platforms and logical platforms. The computing resources may be formed of computing devices, such as servers or other computing devices. The computer resources may be disparate computing resources (e.g., non-identical computing devices). The computer may assign at least one virtual platform on at least one of the corresponding physical and logical platforms, where the at least one virtual platform may be configured to host one or more services for execution by the common computing resources. In hosting the services, the services may be physically located on the virtual platform(s) or assigned thereto. One or more communications channels may be established between at least a portion of the corresponding physical platforms and logical platforms to enable communications to be performed between at least two of the corresponding physical and logical platforms to support the virtual platform(s) operating thereon.

One embodiment for orchestrating computing resources may include receiving a request to automatically configure multiple virtual platforms being operated on common computing resources accessible to a computer. An orchestration engine being executed by the computer may execute steps to configure the virtual platforms with services available to one or more users to utilize when interacting with the virtual platforms. The computer may configure the computer resources to enable a first virtual platform and a second virtual platform to interact with one another so as to enable support for additional resource needs for one of the first or second virtual platform from the other of the first or second virtual platform.

One embodiment for managing computing resources may include communicating with multiple platforms. At least a subset of the platforms may be configured to perform common services. The platforms may include physical platforms and respective logical platforms. The computer may receive a request to perform a service utilizing the platforms. The computer may select a platform to instruct to perform the requested service, and instruct the selected platform to perform the requested service.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure, in the figures, reference numerals designate corresponding parts throughout the different views.

FIG. 1 is an illustration of an illustrative network environment in which common computing resources are utilized to support computing resource needs of users;

FIG. 2 is an illustration of an embodiment of a plurality of platforms configured on computing resources, such as computing resources of FIG. 1, to provide for a network computing operating environment for users;

FIG. 3 is an illustration of an operating system approach to providing services to an application in an illustrative embodiment of common computing resources;

FIG. 3 illustrates a common infrastructure architecture showing various types of managers in a datacenter and their management domains.

FIG. 4 is a flow diagram of an illustrative process for provisioning computing resources;

FIG. 5 is a flow diagram of an illustrative process for orchestrating computing resources; and

FIG. 6 is a flow diagram of an illustrative process for managing computing resources.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

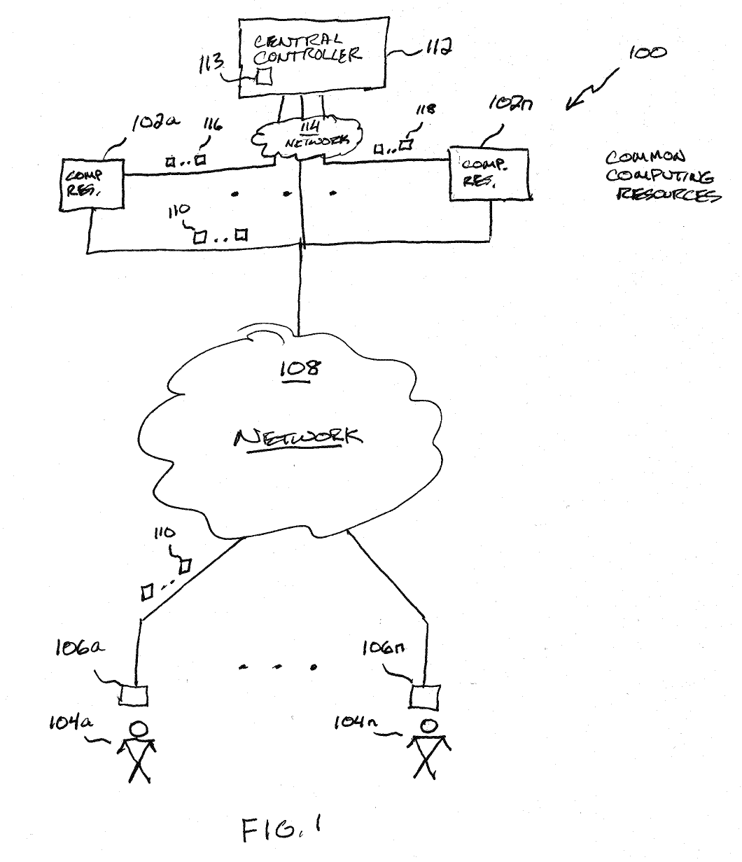

With regard to FIG. 1, an illustration of a network environment 100 provides for common computing resources 102a-102n (collectively 102) that are available to provide computing resources to users 104a-104n (collectively 104). The users 104 may utilize respective computing devices 106a-106n (collectively 106). The computing resources 102 may define or be part of cloud computing with which the computing devices 106 may interact via network 108 to provide computing services for the users 104. The network 108 may be the Internet, mobile communications network, or any other communications network, as understood in the art.

In operation, computing device 106a may communicate data signals 110 via the network 108 to the computing resource 102a. The data signals 110 may be commands, queries, and/or data, as understood in the art. In one embodiment, the data signals may be utilized to provision, orchestrate, and/or operate the computing resources 102. In one embodiment, and as provided herein, commands may be utilized to establish (e.g., provision) platforms for usage by the user 104a, and those platforms may be distinguished or isolated from platforms provisioned by the user 104n.

A central controller 112 may be configured to provide for central or supervisory control over the computing resources 102. In providing central control, the central controller 112 may be configured to provision, orchestrate, manage, or otherwise assist in managing computing resources and/or platforms for respective users 104. In one embodiment, as a user 104a uses the computing device 106a to provision a computing resource to, for example, establish a virtual platform, the computing device 106a may communicate directly with the central controller 112 or the computing resource 102a may relay a request for commissioning to the central controller 112 to cause the central controller to provision the computing resource 102a. For example, the central controller 112 may be configured to determine that a platform needs additional computing resources, and may assist one platform to access computing resources or services provisioned for another platform without exposing data of either platform to the other.

The configuration of the central controller 112 may include management software that enables management of the computer resources 102 irrespective of the users, platforms, or services being performed thereon. In other words, the central controller 112 may operate to allow the computer resources 102 to appear as common computing resources, and enable platforms to access computing resources that heretofore were unavailable to users due to being limited to allocated computing resources. As shown, a network 114, which may be a local area network (LAN), may enable computing resource 102a to request additional services using data signals 116 from the central controller 112, and the central controller 112 may communicate with computing resource 102 and with data 118 to enable computing resource 102a to access or utilize available computing resources and system services from computing resource 102n. The central controller 112 may be configured to assign and record network addresses of the common computing resources 102 along with services available on the respective computing resources 102, thereby enabling the central controller 112 to operate on a higher level than the computing resources to support virtual platform services, for example.

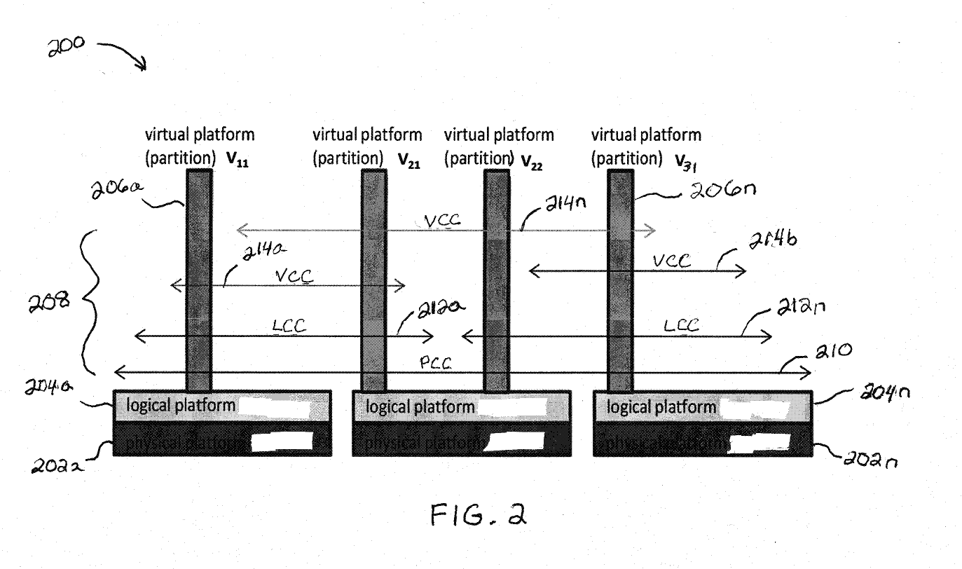

In one embodiment, the management software may include an orchestration engine 113 that operates to orchestrate deployment of a platform, including a virtual platform (see FIG. 2). For example, the orchestration engine 113 may perform steps that cause a virtual platform to be configured with an operating system, services, and communications links. Other central controller modules utilized to provision, orchestrate, and operate the computing resources as further provided herein may be executed by the central controller 112.

FIG. 2 is an illustration of an embodiment of a plurality of platforms 200 configured on computing resources, such as computing resources 102 of FIG. 1, to provide for a network computing operating environment for users. The platforms 200 may include physical platforms 202a-202n (collectively 202), logical platforms 204a-204n (collectively 204), and virtual platforms 206a-206n (collectively 206). The virtual platforms 206 may be defined partitions from the physical platforms 202 and respective logical platforms 204 of common computing resources. One or more virtual platforms 206 may be established on each pair of physical platform 202 and logical platforms 204. As shown, one virtual platform V₁₁, two virtual platforms V₂₁, V₂₂, and one virtual platform V₃₁ provisioned on each of the respective physical and logical platform pairs.

A partition is an alternate name for a virtual platform. Partition or virtual platform actions and platform actions against the physical platform are distinguished. In particular, partition actions may include: creating (e.g., commissioning), modifying (e.g., additional computing resources to be available to the platform), and removing (e.g., decommissioning) partitions on a platform. Platforms actions may include ‘add platform,’ modify, or ‘delete platform.’ The actions for partitions assign resources from a pool of available resources on a platform to a specific partition or return resources to the pool. The actions for platforms add or remove an entire platform or add or remove resources in the pool of resources available on a specific platform that can be assigned to partitions on the platform.

Communications channels 208 may include physical communications channel (PCC) 210, logical communications channels (LCC) 212a-212n (collectively 212), and virtual communications channels (VCC) 214a-214n (collectively 214). The communications channels 208 facilitate communications between components of the common resources on which the platforms 200 are configured. Depending upon the embodiment, the communications channels 200 may include any permutation of three aspects: one or more physical communications channels PCC 210, one or more logical communications channels LCC 212, and one or more virtual communications channels VCC 214. Depending upon the embodiment, there may be any permutation of three platforms: physical platforms 202, logical platforms 204, and virtual platforms 206. It should be understood that the configuration of the platforms 200 is illustrative and that alternative configurations may be utilized, as well.

The physical communications channel PCC may transport data and messages between physical platforms 202 of the common infrastructure. Depending upon the embodiment, the physical communications channels PCC may include a collection of one or more physically isolated communications channel segments, one or more switches, one or more attachment ports, or otherwise to provide for communications with the one or more physical platforms 202.

An isolated communications channel segment includes a transport medium that varies depending upon the embodiment. Non-limiting examples of transport mediums for an isolated segment include: copper wire, optical cable, and/or a memory bus.

Embodiments may vary based on the physical interconnectivity requirements, such as geography, redundancy, and bandwidth requirements. For example, in embodiments where each virtual platform resides on the same physical platform, there is no need for attachment ports or wiring since the virtual platforms are operating on the same physical platform and/or logical platform. Other embodiments may require the communications channels (e.g., physical, logical, and/or virtual communications channels) to span geographic distances using suitable technologies, e.g., LAN or WAN technologies on the common computing resources.

In some embodiments data and messages may be exchanged between physical segments via an optional gateway or router device. In some embodiments, a data center hosting one or more common infrastructures may contain more than one physical communications channels. It should be understood that any communications equipment and communications protocol may be utilized in providing communications between any of the platforms.

A logical communications channel LCC may provide a trusted communications path between sets of platforms or partitions. The logical communications channel LCC may be configured to divide the physical communications channel PCC 210 into logical chunks. For example, a first logical communications channel LCC 212a and a second logical communications channel LCC 212n logically divides the physical communications channel PCC 210.

Each logical communications channel LCC provides a trust anchor for the set of platforms or partitions, which are used to communicate in some embodiments. Embodiments of the communications channels 208 may have a physical communications channel PCC utilizing at least one logical communications channel LCC that enables the trusted communication mechanisms for the logical platforms 204.

The virtual communications channels VCC 214 may provide communications between the virtual platforms 206 to form a virtualized network. For example, in some embodiments, the virtual communications channels VCC 214 are configured using a virtual local access network (VLAN). The logical communications channels LCC 212 may have one or more virtual communications channels VCC 214 defined and operating thereon. For example, a first logical communications channel VCC 212 may host two virtual communications channels VCC 214a, 214n.

The physical platforms 202 are physical computing devices. In some embodiments, a physical platform is a server that slides into a server rack. However, it should be appreciated that any computing device capable of meeting requirements of a physical platform may be utilized. In some embodiments, the physical platform 202 connects to one or more physical communications channels PCC with physical cables, such as InfiniBand or Ethernet cables. In some embodiments, the physical platforms 202 may include an interface card and the related software, such as a Integrated Dell® Remote Access Controller (iDRAC) interface card; and the physical platforms 202 may include BIOS software.

A resource manager (not shown) may reside between a physical platform 202a and a logical platform 204a layer, thereby creating the logical platform 204a from the physical components of the physical platform 202a.

The logical platforms 204 are sets of resources that the resource manager allocates to the virtual platforms 206 creates and/or manages on the physical platform 202, e.g., memory, cores, core performance registers, NIC ports, HCA virtual functions, virtual HBAs, and so on. Depending upon the embodiment, there are two forms of logical platform operation and characteristics. In some embodiments, a logical platform may be a partitionable enterprise partition platform (“PEPP”), and in some embodiments a logical platform may be a non-partitionable enterprise partition platform (“NEPP”).

A PEPP is a logical platform generated by a resource manager that generated one or more virtual platforms 206 that are intended to utilize resources allocated from a physical platform. In some embodiments, the resource manager might only expose a subset of a physical platform's capabilities to the logical platform.

A NEPP is a logical platform that includes all of the hardware components of the physical platform and an agent module that contains credentials that allows the physical platform hosting the NEPP platform, to join the logical communications channel for logical platforms to communicate.

A virtual platform is the collection allocated resources that result in an execution environment, or chassis, created by the resource manager for a partition. A virtual platform may include a subset of resources of a logical platform that were allocated from the physical platform by the resource manager and assigned to a virtual platform.

In some embodiments, componentry of each virtual platform is unique. That is, in such embodiments, the resource manager will not dual-assign underlying components. In other embodiments, however, the resource manager may dual-assign components and capabilities, such as situations requiring dual-mapped memory for shared buffers between partitions. In some embodiments, the resource manager may even automatically detect such requirements.

The services in dialog over the interconnect may be hosted in different virtual platform or in the same virtual platform. Depending upon the embodiment, there may be two types of infrastructure connections: memory connections, and wire connections. Memory connections may be inter-partition or intra-partition communication that may remain within a physical platform.

Wire connections may be connections occurring over an isolated segment, e.g., copper wire, using a related protocol, e.g., Ethernet or InfiniBand. Applications may transmit and receive information through these wire connections using a common set of APIs. The actual transmission media protocols used to control transmission are automatically selected by embedded intelligence of the communications channels 208. Embodiments of an interconnect may provide communication APIs that are agnostic to the underlying transports. In such embodiments of the interconnect, the one interconnect may support all transport protocols.

In the illustrative embodiment, a first virtual platform V₁₁ is capable of communicating with a second virtual platform V₂₁ over a first logical communications channel LCC 212a and a first virtual communications channel VCC 214a. The second virtual platform V₂₁ may communicate with a third virtual platform V₂₂ and a fourth virtual platform V₃₁, over a third virtual communications channel VCC 214n. Communication between the second virtual platform V₂₁ and the third virtual platform V₂₂ has each of the virtual platforms V₂₁, V₂₂ to share the trust anchors of the first and second logical communications channels LCC 212 with the third virtual communications channel VCC 214n because the third virtual communications channel VCC 214n is spans the gap between the logical communication channels LCC 212.

The third virtual platform V₂₂ may communicate with the fourth virtual platform V₃₁ using the second logical communications channel LCC 212n and the third virtual communications channel VCC 214n.

Interconnect communications may be of two types: wire connections and memory connections. Wire connections are inter-server communications requiring sonic use of network transmission protocols, e.g., internet protocol (IP) or InfiniBand (IB) connections. In embodiments requiring wire connections applications may transmit and receive information through wire connections using a common set of APIs.

In some embodiments, the intelligence governing interconnect fabric communications may automatically select the actual transmission media protocols used to during transmissions.

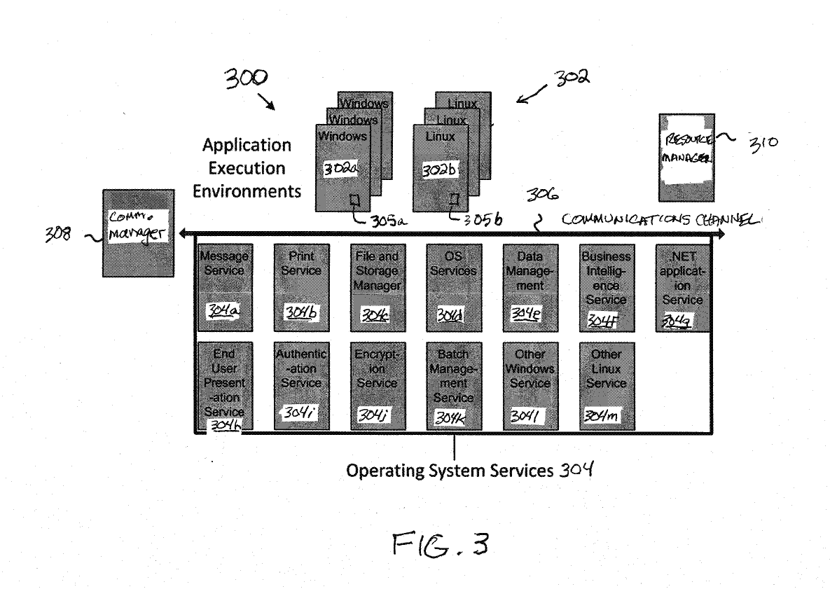

FIG. 3 is an illustration of an application execution system environment 300 to providing services to an application in an illustrative embodiment of a common computing, resources, such as common computing resources 102 of FIG. 1. One or more secure, isolated platforms or application execution environments 302a and 302b (collectively 302) on which an operating system (e.g., Windows® and Linux®) may be configured to be supported by the common computing resources 102. The platforms 302 may be virtual platforms, as understood in the art. The common computing resources 102 may include a computer, such as a server, inclusive of typical computing hardware (e.g., processor(s), memory, storage device(s)), firmware, and other software. Operating system services or services 304 that provide for processes and functions typical of computing support services may be provided for inclusion and/or access to the platforms 302. In the case where the respective platforms 302 have the services incorporated thereon, then each of the platforms 302 may operate independent of the others. An administrator may commission the operating system and services 304 for operation on a platform 302a, for example, and may customize the services and/or computing resources (e.g., disk drive storage space) for the platform 302a. Management agents 305a and 305b (collectively 305) may be installed on the platforms 302. In one embodiment, the management agents 305 may be installed on physical platforms and used to manage available resources thereon. Alternatively and/or additionally, the management agents 305 may be installed on virtual platforms to manage resources utilized by the virtual platforms.

The system services 304, which execute independently of the application platforms 302a, 302b, may execute independently of each other to provide services in support of the applications hosted in the platforms 302. The services may include a messaging service 304a, print service 304b, file and storage manager 304c, OS services 304d, data management 304e, business intelligence service 304f, .net application service 304g, end user presentation service 304h, authentication service 304i, encryption service 304j, batch management service 304k, other Windows® service 304l, and other Linux®.) service 304m. It should be understood that additional and/or alternative services may be provided with the system services 304. It should also be understood that each user may elect to configure a platform with some or all of the services 304. Depending upon the embodiment, and based on the needs of the service being hosted in each of the platforms 302, an operating system of a platform 302a may range from a simple hardware adaptation layer to an integrated operating system.

A communications channel 306 may provide for communications between the computing resources, such as physical and logical platform(s), and virtual platform(s). A communications manager 308 may be configured to support communications between some or all of the platforms. In certain embodiments, when creating or commissioning a new platform 302a, for example, an administrator may select the services to manage hardware supporting the virtual platform. Alternatively, a “blueprint” may be utilized to enable automatic provisioning, commissioning, and orchestration of the virtual platform. A non-limiting example of a new platform 302a may be a simple hardware adaptation layer, a microkernel operating system, or a full integrated operating system environment.

The services 304 related to a first platform or application execution environment 302a may execute independently from services 304 related to a second application execution environment 302b. Moreover, each of these platforms 302a, 302b may execute independently from each of the services 304.

Depending upon the embodiment, operating systems on respective platforms 302 may range from a simple hardware adaptation layer to a sophisticated integrated operating system. The particular operating system for a partition in an illustrative embodiment may be based on functionalities desired by users of the respective platforms 302.

The communications channel 306 provides interconnectivity among the platforms 302a, 302b and the system services 304 provided for their use. The communications channel 306 may support physical, logical, and virtual communications channels, as described in FIG. 2. In some embodiments, the communications channel 306 may be a high-speed, low-latency interconnection protocol and/or hardware, which may employ technologies such as InfiniBand or other high-speed, low-latency connectivity technology. It should be understood that any communications protocol, hardware, and software may be utilized to provide for communications between and amongst platforms, including physical, logical, and/or virtual platforms, as described herein.

The communications manager 308 may execute as a part of the common computing resources 102, but independently of the platforms 302a, 302b and independently of the system services 304. The communications channel 306 may provide interconnectivity between components, perform various security functions, and perform one or more management duties for the computing resources. The interconnect is managed by the communications manager 106.

An operating system of the communications manager 308 is different from any of the operating systems integrated on the platforms 302 because the operating system and the operating system services 304 execute independently on their own virtual platforms, i.e., partitions 302. That is, the operating system of the communications manager 308 is distinct from each distributed operating system being utilized by the virtual platforms 302. In other words, each virtual platform 302 hosts its own homogeneous operating system. The distributed operating system environment 300 is a heterogeneous environment that is the sum of constituent parts, e.g., the operating systems operating on the platforms 302 and the communications manager 308.

The operating systems being executed in the platforms 302 of the application execution system environment 300 may each be hosted on independent physical and/or virtual platforms. However, the application execution system environment 300 projects a homogenous integrated operating system view to each of the applications that are hosted within the application execution system environment 300, thereby obscuring and/or hiding the distributed nature of the underlying services supplied from the applications and/or services 304 in the application execution system environment 300.

In one embodiment, a resource manager 310 may be configured to manage computing resources along with service resources for the platforms 302. In managing the resources for the platforms 302, the resource manager 310 may enable communications via the communications channel 306.

An embodiment of an operating system provided by the application execution system environment 300 includes the constituent heterogeneous operating systems residing on platforms 302, which in some cases include one or more integrated operating systems. By contrast, in conventional network operating systems, all participating devices in the network environment, or nodes, are assumed to be homogeneous. Embodiments of a operating system provided by the application execution system environment 300 are not constrained by homogeneity. The nodes in a conventional network operating system focus on a means for allowing the nodes to communicate. In some embodiments, the operating system provided by the application execution system environment. 300 may implement a communications channel 306 as just one in a plurality of possible services.

A conventional network operating system focuses on providing a service, such as a file server service, for example, for a client-server software application. Embodiments of an operating system provided by the application execution system environment 300 may include the software application execution environments in addition to the service provider environments. That is, the application execution system environment 300 may not follow a client-server model. In certain embodiments, the application execution system environment 300 may separate between the virtual platforms 302 and the service environments, but may not include the management of the common infrastructure environment provided by the communications manager 308, nor the security or isolation provided by the communications channel 306 and communications manager 308.

In some embodiments, the application execution system environment 300 uses native APIs provided by the services 304 of the constituent operating system and component applications operating on the platforms 302. A operating system provided by the application execution system environment 300 does not enforce a single set of APIs between the service providers and the service consumers, and is therefore more robust than a conventional enterprise service bus.

The heterogeneous operating system model of the application execution system environment 300 uses the communications channel 306 to utilize the services 304 residing in each of the separate heterogeneous execution environments, such as platforms 302. Thus, services 304 may traverse platforms 302, from a first operating system image to another, as though local to the first operating system image. That is, in some embodiments, the set of all services across the platforms 302 may present the same behaviors of a constituent operating system.

Operating System Images, Blueprints, and Commissioning

In some embodiments, a customer may select from one or more possible operating systems to implement on the platforms 302. Depending upon the embodiment, operating system images may provide choice of preconfigured operating system blueprints that may be quickly deployed, easily cloned, and maintained.

In embodiments utilizing blueprints, the resource manager 310 may create the platforms 302 and populate the platforms 302 quickly with blueprinted images. That is, platforms 302 may be generated using a blueprint. High levels of automation for provisioning, commissioning, and orchestrating operating systems and managing runtime operation enhances resilience and availability and also reduces operational costs.

One architecture for application management is provided by the OASIS standard called TOSCA. Many application management technologies have leveraged different portions of TOSCA, including provisioning. Five major components provided by TOSCA architecture include:

(i) node type (class from which node templates may be derived, and which include attributes: properties, capabilities, interfaces, and requirements,

(ii) relationship type (defines relationships between node types),

(iii) deployment artifacts (software elements required to be deployed as services, such as VM images, source code, etc.),

(iv) implementation artifacts (artifacts, such as scripts, that are used to provide infrastructure provisioning automation), and

(v) orchestration engine (higher level automation that manages overall process flow and complex events involved with management of an application as a whole, and which determines order in which provisioning automation is invoked).

There are two approaches for defining relationships, including an imperative approach and a declarative approach. The imperative approach follows a deterministic set of rules, independent of the actual environment during the time that the nodes are being commissioned. The declarative approach uses additional intelligence that depends on a current condition of the environment. For the declarative approach, TOSCA recommends “base” relationships, including “HostedOn,” “DependsOn,” and “ConnectsTo,” and these relationships are used to guide an orchestration.

Conventional orchestration has been primarily focused on coordinating underlying infrastructure provisioning tasks. Enterprise applications have had limited development, and are provided for in certain embodiments. For example, high availability of an application may be specified, and the orchestration engine 113 (FIG. 1) may be configured to guarantee that a single failure would not violate the “depends on” relationship, and, therefore, the application may continue delivering services in the event of a single failure. Also, if disaster recovery is mandated, the orchestration engine 113 may position resources in multiple physical resources (e.g., physical platforms 202 of FIG. 2). If strict security or end-to-end performance constraints were mandated, then the orchestration engine 113 may select specific application execution environment, such as application execution environment 300 of FIG. 3, that support the constraints. Other embodiments for the orchestration engine 113 support provisioning or other functionality are possible.

Provisioning Computer Resources

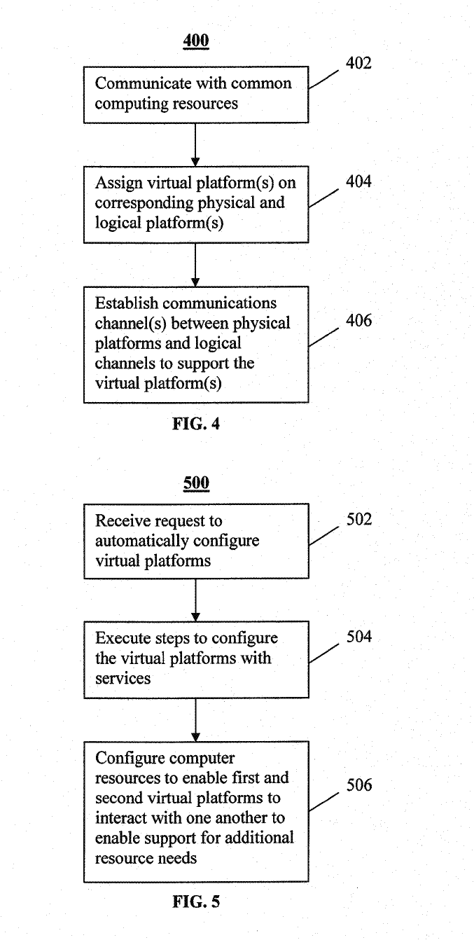

With regard to FIG. 4, a flow diagram of an illustrative process 400 for provisioning computing resources is shown. The process 400 may start at step 402, where a communication, by a computer, with multiple common computing resources may be performed. The computing resources may be inclusive of multiple corresponding physical platforms and logical platforms. The computing resources may be formed of computing devices, such as servers or other computing devices. The computer resources may be disparate computing resources (e.g., non-identical computing devices). At step 404, the computer may assign at least one virtual platform on at least one of the corresponding physical and logical platforms, where the at least one virtual platform may be configured to host one or more services for execution by the common computing resources. In hosting the services, the services may be physically located on the virtual platform(s) or assigned thereto. At step 406, one or more communications channels may be established between at least a portion of the corresponding physical platforms and logical platforms to enable communications to be performed between at least two of the corresponding physical and logical platforms to support the virtual platform(s) operating thereon.

In one embodiment, a management agent may be automatically installed on the corresponding physical and logical platforms to manage available resources thereon. A service may be installed in each of the virtual platform(s) to be executed by the computing resources. Communicating with the common computing resources may include communicating with at least two physical platforms, where the at least two physical platforms are disparate physical platforms. Moreover, establishing the communications channel(s) may include establishing physical communications channels that provide for communications thereon for the common computing resources.

In an embodiment, logical communications channels may be established along the physical communications channels to define sub-communications channels between at least a portion of the common computing resources. Assigning at least one virtual platform may include assigning at least two virtual platforms that are configured to execute services for a single user, and one or more communications channels may further include establishing at least one virtual communications channel between at least two of the virtual platforms.

In one embodiment, the computer may automatically partition the corresponding physical and logical platforms, and a virtual platform may be configured on the physical and logical platforms. Network address information of each of the corresponding physical and logical platforms may be mapped, and the mapped network address information may be stored.

An application may be executed on the virtual platform(s) for a particular user. In addition, the computer may be configured with a software management system to operate as a central controller relative to the common computing resources. By operating as a central controller, the computer may be able to control operations, including interacting operations, of the virtual platforms.

In an embodiment, a communications manager module may be configured to manage data being communicated over the one or more communications channels. Additionally, a blueprint may be applied to configure a virtual platform to cause the virtual platform to be configured automatically in accordance with the blueprint.

In yet another embodiment, at least one first virtual platform may be assigned for a first user and at least one second virtual platform may be assigned for a second user, where the first user has access to the first virtual platform and not the second virtual platform, and the second user having access to the second virtual platform and not the first virtual platform. The one or more services available on each of the first and second virtual platforms may be recorded. The first virtual platform may be enabled to access a service on the second virtual platform in response to determining that additional services contained on the second virtual platform are needed by the first virtual platform. In determining that additional services are needed may include receiving a request for additional services. Determining that additional services are needed may further include that the first virtual platform(s) needs additional services not available on the first virtual platform and available on the second virtual platform as determined by the computer from the recorded services of the second virtual platform.

Still yet, at least one first virtual platform may be assigned for a first user and at least one second virtual platform may be assigned for a second user on the common computing resources, where the first user has access to the first virtual platform and not the second virtual platform, and the second user has access to the second virtual platform and not the first virtual platform. Resources available from the common computing resources on which the first virtual platform and the second virtual platform are operating may be monitored, In response to determining that additional resources are needed by the first virtual platform, the computer may enable the first virtual platform to access resources available on the second virtual platform. In determining that additional resources are needed may include receiving, by the computer, a request for additional resources. In determining that additional resources are needed may include determining, by the computer, that the common computing resources on which the first virtual platform(s) is operating are insufficient to support needs of the first virtual platform and available on the common computing resources on which the second virtual platform is operating.

Orchestrating Computing Resources

With regard to FIG. 5, a flow diagram of an illustrative process 500 for orchestrating computing resources is shown. The process 500 may start at step 502, where a computer may receive a request to automatically configure multiple virtual platforms being operated on common computing resources accessible to the computer. At step 504, an orchestration engine being executed by the computer may execute steps to configure the virtual platforms with services available to one or more users to utilize when interacting with the virtual platforms. At step 506, the computer may configure the computer resources to enable a first virtual platform and a second virtual platform to interact with one another so as to enable support for additional resource needs for one of the first or second virtual platform from the other of the first or second virtual platform.

In one embodiment, the virtual platforms being supported by one or more associated physical platforms and logical platforms may be accessed by the computer. The available resources of the first virtual platform and second virtual platform may be automatically managed by management agents associated with the respective virtual platforms, and be executed on the one or more physical platforms on which the respective first and second virtual platforms are operating.

Interactions between the first and second virtual platforms may be coordinated in response to a signal received from one of the management agents by the computer. In coordinating the interactions, the interactions may be coordinated between the first and second virtual platforms over one or more communications channels existing between the first and second virtual platforms. The one or more communications channels may includes at least one of (i) one or more physical communications channels, (ii) one or more logical communications channels, and (iii) one or more virtual communications channels.

In an embodiment, the computer may continuously monitor the first and the second virtual platforms. Continuously monitoring may include continuously polling the first and second virtual platforms, and a determination of status of resource availability of the first and second virtual platforms based on data received back from the polled first and second virtual platforms may be made. Continuously monitoring may alternatively include receiving update communications from the first and second virtual platforms, and a determination of status of resource availability of the first and second virtual platforms may be made based on data received from the polled first and second virtual platforms.

In configuring the computer to enable support for additional resource needs may include configuring the computer to enable support for a service available on the first or second virtual platform. Configuring the computer to enable the first and second virtual platforms to interact with one another may include configuring the computer to enable the first and second virtual platforms to interact with one another across a communications channel when the first and second virtual platforms are operating on at least two different physical platforms. At least two of the physical platforms may include at least two disparate physical platforms. Still yet, configuring the computer to enable the first and second virtual platforms to communicate with one another may include configuring the computer to provide for interaction between the first and second virtual platforms across a partition established on the common computing resources.

In an embodiment, a communications manager module may be configured on the computer to manage data being communicated between the first and second virtual platforms. The communications manager module may be configured to support physical, logical, and virtual communications channels, as described in FIG. 2.

Managing Computing Resources

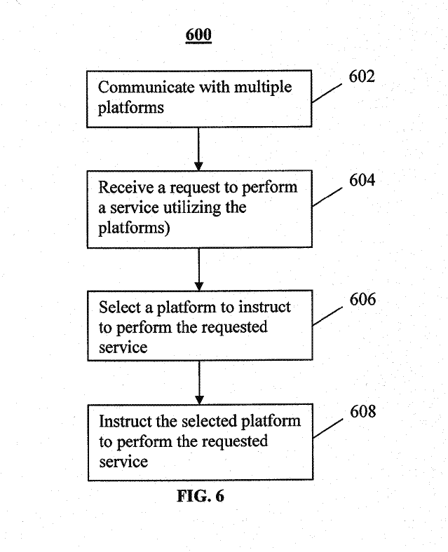

With regard to FIG. 6, a flow diagram of an illustrative process 600 for managing computing resources is shown. The process 600 may start at step 602, where a computer may communicate with multiple platforms, where at least a subset of the platforms are configured to perform common services. The platforms include physical platforms and respective logical platforms. At step 602, the computer may receive a request to perform a service utilizing the platforms. At step 604, the computer may select a platform to instruct to perform the requested service, and at step 608, the computer may instruct the selected platform to perform the requested service.

In determining which of the platforms to instruct to perform the requested service, a determination may be made to instruct multiple platforms to collectively perform the service. Instructing the selected platform may include instructing the selected platform to perform a data storage service. Communicating with multiple platforms may include communicating with multiple disparate platforms. Communicating with the platforms may include communicating via a physical communications channel.

One embodiment may include mapping network address information of each of the platforms, storing the mapped network address information, accessing the stored mapped network address information in response to receiving the request to perform the service, and instructing the selected platform may include instructing the selected platform using the mapped network address information of the selected platform. In an embodiment, establishing partition information on the platforms) to establish at least one partition for different users may include mapping the established partition information, storing the mapped partition information, accessing the stored mapped partition information in response to receiving the request to perform the service, and instructing the selected platform may include instructing the selected platform using the mapped network address information and the mapped partition information.

Establishing the partition information may include establishing a virtual partition on the at least one of the platforms. The process may further include executing an application in at least one of the partitions of the platforms. In response to instructing the selected platform to perform the requested service, an indication that the application performs the service may be received. The application may be limited to be executed in the partition(s) of the platforms for a particular user.

One embodiment may further include configuring the computer to operate as a central controller relative to the plurality of platforms. A determination as to which of the platforms to instruct to perform the requested service may include determining which of the platforms are configured with an application capable of performing the service.

In an embodiment, a determination as to which of the platforms to instruct to perform the requested service may include monitoring resource availability of the platforms, determining which of the platforms have resource availability, and where selecting the platform may include selecting the platform based on which of the platforms are determined to have resource availability.

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, the function termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for managing computing resources, said method comprising:
communicating, by a computer, with a plurality of platforms, at least a subset of platforms configured to perform common services, the platforms including physical platforms and respective logical platforms;
receiving, by the computer, a request to perform a service utilizing the platforms;
selecting, by the computer, a platform to instruct to perform the requested service; and
instructing, by the computer, the selected platform to perform the requested service.

2. The method according to claim 1, wherein determining which of the platforms to instruct to perform the requested service includes determining a plurality of platforms to instruct to collectively perform the service.

3. The method according to claim 1, wherein instructing the selected platform includes instructing the selected platform to perform a data storage service.

4. The method according to claim 1, wherein communicating with a plurality of platforms includes communicating with a plurality of disparate platforms.

5. The method according to claim 1, wherein communicating with a plurality′ of platforms includes communicating via a physical communications channel.

6. The method according to claim 1, further comprising:
mapping network address information of each of the platforms;
storing the mapped network address information;
accessing the stored mapped network address information in response to receiving the request to perform the service; and
wherein instructing the selected platform includes instructing the selected platform using the mapped network address information of the selected platform.

7. The method according to claim 6, further comprising:
establishing partition information on at least one of the platforms to establish at least one partition for different users;
mapping the established partition information;
storing the mapped partition information;
accessing the stored mapped partition information in response to receiving the request to perform the service; and
wherein instructing the selected platform includes instructing the selected platform using the mapped network address information and the mapped partition information.

8. The method according to claim 8, wherein establishing the partition information includes establishing the partition information on the at least one of the platforms.

9. The method according to claim 7, further comprising:
executing an application in at least one of the partitions of the platforms;
in response to instructing the selected platform to perform the requested service, receiving an indication that the application performs the service.

10. The method according to claim 9, wherein the application is limited to be executed in the at least one of the partitions of the platforms for a particular user.

11. The method according to claim 1, further comprising configuring the computer to operate as a central controller relative to the plurality of platforms.

12. The method according to claim 1, wherein determining which of the platforms to instruct to perform the requested service includes determining which of the platforms are configured with an application capable of performing the service.

13. The method according to claim 1, wherein determining which of the platforms to instruct to perform the requested service includes:
monitoring resource availability of the platforms;
determining which of the platforms have resource availability; and
wherein selecting the platform includes selecting the platform based on which of the platforms are determined to have resource availability.
